(19) United States
(12) Patent Application Publication
(10) Pub. No.: US 2017/0270963 A1
(43) Pub. Date: Sep. 21, 2017

(54) MAGNETIC DISK DEVICE, DATA PROCESSING DEVICE AND RECORDING METHOD

(71) Applicant: Kabushiki Kaisha Toshiba, Tokyo (JP)

(72) Inventor: Nobuhiro Maeto, Yokohama Kanagawa (JP)

(21) Appl. No.: 15/252,612

(22) Filed: Aug. 31, 2016

Related U.S. Application Data
(60) Provisional application No. 62/309,523, filed on Mar. 17, 2016.

(51) Int. Cl. G11B 20/18; G06F 11/10

(52) U.S. Cl. CPC G11B 20/1833; G06F 11/1076; G11B 20/1866

(57) ABSTRACT

According to one embodiment, sector groups are generated from M (M is an integer of 2 or larger) sector data, one parity sector unit is generated from N (N is an integer of 1 or larger) sector groups in which the M sector data are interleaved for the individual sector groups, and one parity sector group in which K (K is as integer of 2 or larger) parity sectors corresponding to K parity sector units are turned into long sector is generated.

### CROSS-REFERENCE TO RELATED APPLICATIONS

This application is based upon and claims the benefit of priority from U.S. Provisional Application No. 62/309,523, filed on Mar. 17, 2016; the entire contents of which are incorporated herein by reference.

### FIELD

Embodiments described herein relate generally to a magnetic disk device, a data processing device, and a data recording method.

### BACKGROUND

In a magnetic disk device, parity data is added to allow errors in sector data recorded in a magnetic disk to be corrected.

### BRIEF DESCRIPTION OF THE DRAWINGS

FIG. 1 is a schematic block diagram of a magnetic disk device according to an embodiment;

FIG. 2 is a plane view of a sector arrangement example on a magnetic disk illustrated in FIG. 1;

FIG. 3 is a block diagram of a configuration example of an encoding unit illustrated in FIG. 1;

FIG. 4A is a diagram illustrating an example of host data applied to the magnetic disk device according to the embodiment, and FIG. 4B is a diagram illustrating an example of an interleaving scheme of host data applied to the magnetic disk device according to the embodiment;

FIG. 5 is a block diagram illustrating an example of a generating scheme of a parity sector from sector data applied to the magnetic disk device according to the embodiment;

FIG. 6 is a diagram illustrating an example of media data written into the magnetic disk in the magnetic disk device according to the embodiment;

FIG. 7 is a flowchart of an example of a generating method of the media data applied to the magnetic disk device according to the embodiment;

FIG. 8 is a block diagram of a configuration example of a decoding unit illustrated in FIG. 1; and

FIG. 9 is a flowchart of an example of a decoding scheme of the media data applied to the magnetic disk device according to the embodiment.

### DETAILED DESCRIPTION

In general, according to one embodiment, a magnetic disk device generates sector groups from M (M is an integer of 2 or larger) sector data, generates one parity sector unit from N (N is an integer of 1 or larger) sector groups in which the M sector data are interleaved for the individual sector groups, and generates one parity sector group in which K (K is an integer of 2 or larger) parity sectors corresponding to K parity sector units are turned into long sector.

Exemplary embodiments of a magnetic disk device will be explained below in detail with reference to the accompanying drawings. The present invention is not limited to the following embodiments.

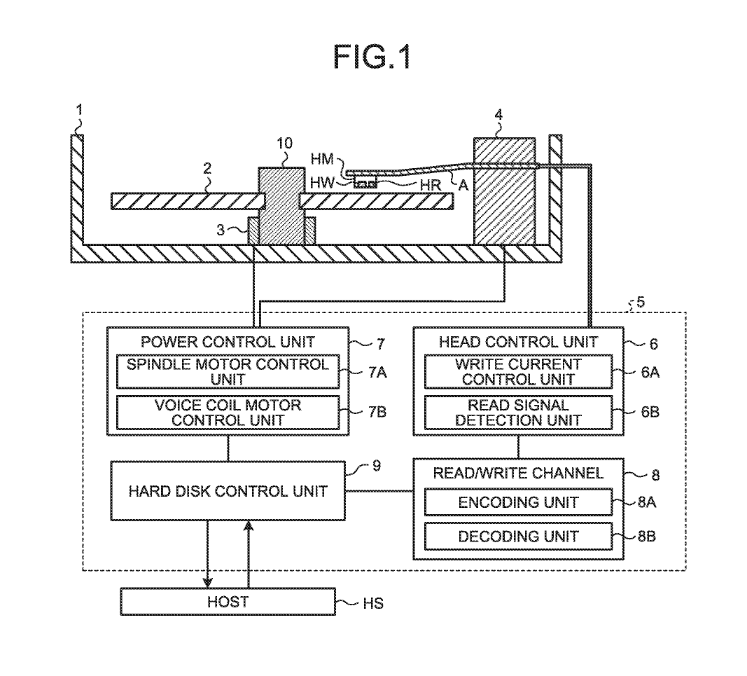

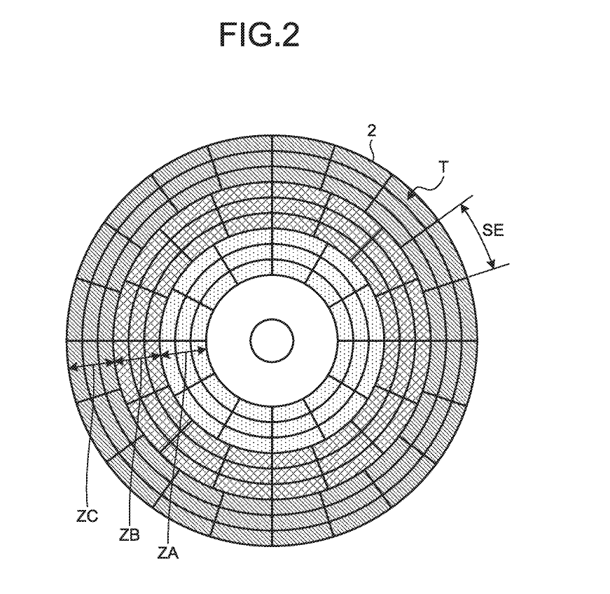

FIG. 1 is a schematic block diagram of a magnetic disk device according to an embodiment. FIG. 2 is a plane view of a sector arrangement example on a magnetic disk illustrated in FIG. 1.

Referring to FIG. 1, the magnetic disk device includes a magnetic disk 2. The magnetic disk 2 is supported by a case 1 via a spindle 10. The magnetic disk device also includes a head slider HM. The head slider HM includes a write head HW and a read head HR as magnetic head. The write head HW and the read head HR are opposed to the magnetic disk 2. The head slider HM is held over the magnetic disk 2 via an arm A. The arm A can slide the head slider HM in a horizontal plane during the seek or the like.

As illustrated in FIG. 2, the magnetic disk 2 includes tracks T in a circumferential direction. The tracks T are divided into sectors SE. The sector SE can be the minimum recording unit of the magnetic disk 2. The magnetic disk 2 is radially divided into zones ZA, ZB, and ZC. The number of sectors in the individual tracks T can vary among the zones ZA, ZB, and ZC. The number of sectors can be larger on the outer periphery than on the inner periphery.

Returning to FIG. 1, the magnetic disk device includes a voice coil motor 4 that drives the arm A and a spindle motor 3 that rotates the magnetic disk 2. The magnetic disk 2, the head slider HM, the arm A, the voice coil motor 4, and the spindle motor 3 are housed in the case 1.

The magnetic disk device is also provided with a control unit 5. The control unit 5 includes a head control unit 6, a power control unit 7, a read/write channel 8, and a hard disk control unit 9. The control unit 5 can control positions of the write head HW and the read head HR based on servo data read by the read head HR.

The head control unit 6 includes a write current control unit 6A and a read signal detection unit 6B. The power control unit 7 includes a spindle motor control unit 7A and a voice coil motor control unit 7B. The read/write channel 8 includes an encoding unit 8A and a decoding unit 8B.

The head control unit 6 amplifies or detects a signal at the recording or reading time. The write current control unit 6A can control write current flowing into the write head HM, The read signal detection unit 6B can detect a signal read by the read head HR.

The power control unit 7 can drive the voice coil motor 4 and the spindle motor 3. The spindle motor control unit 7A can control rotation of the spindle motor 3. The voice coil motor control unit 7B can control driving of the voice coil motor 4.

The read/write channel 8 can exchange data between the head control unit 6 and the hard disk control unit 9. The data include read data, write data, and servo data. For example, the read/write channel 8 can convert the signal read by the read head HR into a data format to be treated by a host HS, and can convert data output from the host HS into a signal to be recorded by the write head HW. These format conversion include DA conversion, encoding, AD conversion, and decoding. The read/write channel 8 can also decode the signal read by the read head HR, and can perform code modulation of the data output from the host HS.

The encoding unit 8A can encode write data to be written into the magnetic disk 2. The encoding unit 8A can encode individual sector data included in the write data with low-density parity-check codes (LDPC). The sector data is data specified by the host HS with one logical address. The encoding unit 8A also generates sector groups from M (M is an integer of 2 or larger) sector data, and generates one parity sector unit from N (N is an integer of 1 or larger) sector groups in which sector data are interleaved for the individual sector groups.

The encoding unit 8A also generates one parity sector group in which K (K is an integer of 2 or larger) parity sectors corresponding to K parity sector units are turned into long sectors. The decoding unit 8B can decode read data from the magnetic disk 2. The decoding unit 8B can decode the individual sector data with the LDPC codes. The decoding unit 8B can also correct errors in the sector data based on the parity sector units and the parity sectors read from the magnetic disk 2.

The hard disk control unit 9 can perform record/read control and exchange data between the outside and the read/write channel 8 based on an instruction from the outs de of the magnetic disk device. The hard disk control unit 9 may include a general-purpose processor performing the record/read control and a dedicated processor exchanging data between the host HS and the read/write channel 8. The control unit 5 is connected to the host HS. The host HS may be a personal computer that issues a write command, a read command, and the like to the magnetic disk device or may be a network connectable to a server or the like. That is, the magnetic disk device is used as an external memory device of the host HS. The magnetic disk device may be provided outside the host HS or may be built in the host HS.

At the time of writing data into the magnetic disk 2, while the magnetic disk 2 is rotated by the spindle motor 3, write data is sent from the host HS to the read/write channel 8 via the hard disk control unit 9. At that time, the encoding unit 8A encodes the individual sector data to be written into the magnetic disk 2 by the LDPC codes. In addition, the encoding unit 8A generates parity sectors for the individual sector units to be written into the magnetic disk 2. Then, K (K is an integer of 2 or larger) parity sector units are continuously written into the magnetic disk 2 via the write head HW.

At the time of writing the parity sector units, the number of the sectors can be counted and the parity sector units can be divided by the number of the sectors. For example, when one parity sector unit is composed of three sector groups including four each sector data, the parity sector unit can be divided by 4×3=12 sectors. The parity sector unit can be configured on a cyclical basis. For example, when the parity sector unit is divided by 12 sectors, a plurality of parity sector units can be continuously written into the magnetic disk 2 in a cycle of 12 sectors.

The cycle of the parity sector unit may be variable depending on the number of sectors. In addition, K parity sectors are generated for K parity sector units, and one parity sector group is generated from the K parity sectors. Then, the parity sector groups that are turned into long sectors by interleaving the K parity sectors corresponding to the K parity sector units are written into the magnetic disk 2 via the write head HW. At that time, the parity sector groups are written into the magnetic disk 2 subsequent to the Kth parity sector unit.

At the time of reading data from the magnetic disk 2, while the magnetic disk 2 is rotated by the spindle motor 3, a signal is read from the magnetic disk 2 via the read head HR, and the read signal is detected by the read signal detection unit 6B. The signal detected by the read signal detection unit 6B is subjected to data conversion by the read/write channel 8, and sent to the hard disk control unit 9.

At that time, the decoding unit 8B decodes the individual sector data by the LDPC codes. The parity sector group including a plurality of parity sectors corresponding to the parity sector units is read from the magnetic disk 2. When one sector data in one read parity sector unit has an error, M×N−1 sector data without error in the one parity sector unit and one parity sector corresponding to the one parity sector are subjected to exclusive OR (XOR) operation for the individual bits to restore the one sector data with the error.

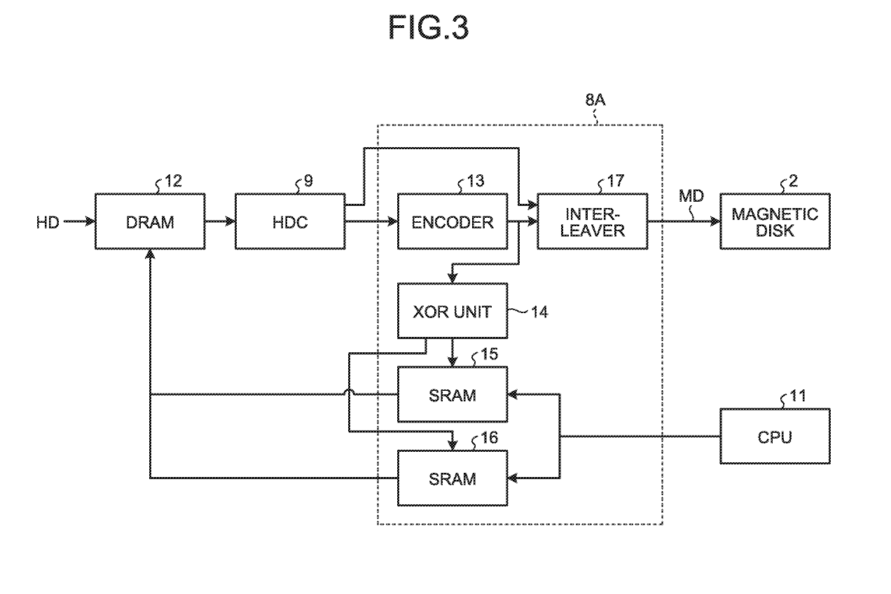

FIG. 3 is a block diagram of a configuration example of the encoding unit 8A illustrated in FIG. 1.

Referring to FIG. 3, the encoding unit 8A includes an encoder 13, an XOR unit 14, SRAMs 15 and 16, an interleaver 17. The encoder 13 can encode individual sector data by the LDPC codes. The XOR unit 14 can generate parity sectors by subjecting M×N sector data in one parity sector unit to an XOR operation for the individual bits. The SRAMs 15 and 16 can store alternately the parity sectors generated by the XOR unit 14.

The interleaver 17 can interleave the sector data included in the parity sector unit for the individual sector groups and interleave the parity sectors included in the parity sector group. DRAM 12 is provided at the stage preceding the hard disk control unit 9. The DRAM 12 can be used as a buffer storing host data HD sent from the host HS and store K parity sectors stored in the SRAMs 15 and 16. The SRAMs 15 and 16 can be controlled by the CPU 11. The CPU 11 can switch between the SRAMs 15 and 16 for storing the parity sectors and store the parity sectors stored in the SRAMs 15 and 16 into the DRAM 12. The CPU 11 can also control the overall operations of the encoding unit 8A, the hard disk control unit 9, and the DRAM 12.

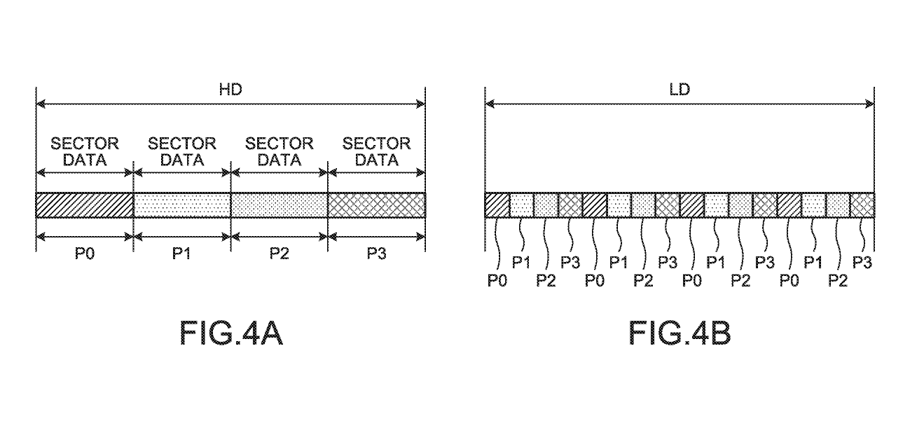

FIG. 4A is a diagram illustrating an example of host data applied to the magnetic disk device according to the embodiment, and FIG. 4B is a diagram illustrating an example of an interleaving method of host data applied to the magnetic disk device according to the embodiment.

Referring to FIG. 4A, for example, four sector data P0 to P3 of 4 Kbytes can be given as host data HD. The sector data P0 to P3 may have 512 bytes or any other data length.

Referring to FIG. 4B, the sector data P0 to P3 can be interleaved to generate data LD in which the sector data P0 to P3 are turned into long sectors. By interleaving the sector data P0 to P3, it is possible to disperse damage resulting from faults and misalignments at the time of writing and improve LDPC correction probability (probability of error correction enabled by LDPC).

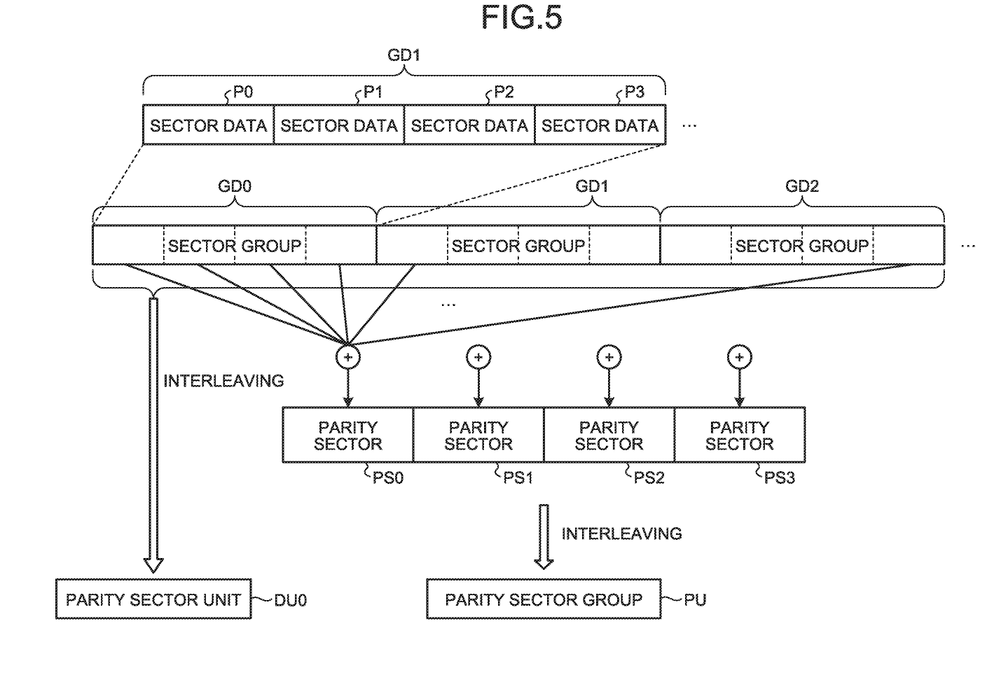

FIG. 5 is a block diagram illustrating an example of a generating method of one parity sector from a plurality of sector data applied to the magnetic disk device according to the embodiment. FIG. 5 illustrates a generating method for one sector group from four (M=4) sector data and a generating method of one parity sector unit from three (N=3) sector groups. FIG. 5 also illustrates a generating method of one parity sector from three sector groups and a generating method of a parity sector group from four (K=4) parity sectors. To commonly use the processing unit at the time of interleaving, M and K are desirably equal. In the example of FIG. 5, the number of parity sectors PS0 to PS3, K=4, and the number of sector data in the sector groups GD0 to GD2, M=4, are equal.

The sector group is a group including a plurality of sector data before interleaving. The parity sector unit is data generated from a plurality of sector groups in which sector data is interleaved for the individual sector groups. The parity sector is parity data for one sector. The parity sector group is data in which a plurality of parity sectors is turned into long sectors. The long-sectored data is interleaved data.

Referring to FIG. 5, one sector group GD0 is composed of four sector data P0 to P3. The sector groups GD1 and GD2 can also be each composed of four sector data. The sector groups GD0 to GD2 are collections of a plurality of sector data. That is, the sector groups GD0 to GD2 are data with data length of four sectors. The three sector groups GD0 to GD2 can be individually interleaved to generate one long-sectored parity sector unit DU0. In addition, the sector data in the three sector groups GD0 to GD2 in the parity sector unit DU0 can be subjected to an XOR operation for the individual bits to generate a parity sector PS0.

Similarly to the generation of the parity sector unit DU0, a parity sector unit DU1 can be generated from other three sector groups GD3 to GD5, a parity sector unit DU2 can be generated from still other three sector groups GD6 to GD8, and a parity sector unit DU3 can be generated from still other three sector groups GD9 to GD11. At that time, the parity sector units DU0 to DU3 are data with a data length of 4×3=12 sectors.

Then, the sector data in the three sector groups in the parity sector unit DU1 can be subjected to an XOR operation for the individual bits to generate a parity sector PS1. The sector data in the three sector groups of the parity sector unit DU2 can be subjected to an XOR operation for the individual bits to generate a parity sector PS2. The sector data in the three sector groups in the parity sector unit DU3 can be subjected to an XOR operation for the individual bits to generate a parity sector PS3. The four parity sectors PS0 to PS3 are data with an overall data length of four sectors. The four parity sectors PS0 to PS3 can be interleaved to generate one long-sectored parity sector group PU.

For example, when any one of the twelve sector data in the parity sector unit DU0 has an error, the one sector data with the error can be restored by performing an XOR operation with the eleven sector data without error in the twelve sector data and the one parity sector PS0 for the individual bits.

The procedure for the correction will be explained with an example. When a transmission polynomial is designated as F(x) and a generation polynomial for generating an error correction code is designated as G(x), an encoded polynomial S(x) in which the transmission polynomial F(x) is encoded can be expressed by the following equation (1):

F(x)*G(x)=S(x) (1)

At the receiving side, an error syndrome E(x) indicating error information in a reception polynomial is calculated by the following equation (2):

S(x)/G(x)=E(x) (mod G(x)) (2)

When the reception polynomial includes no error, E(x) equals to 0.

For example, when transmission polynomials for the sector data P1 and P2 are designated as F1(x) and F2(x), encoded polynomials for the sector data P1 and P2 are designated as S1(x) and S2(x), an XOR operation value of the encoded polynomials S1(x) and S2(x) is designated as SP(x), and an error syndrome is designated as EP(x), the following equations (3) to (5) can hold:

S1(x)+S2(x)=SP(x) (3)

(F1(x)+F2(x))*G(x)=SP(x) (4)

SP(x)/G(x)=EP(x) (mod G(x)) (5)

As a result, the XOR operation value SP(x) can also be a code word generated by the generation polynomial G(x).

Assuming that the XOR operation value SP(x) is a parity sector, when only one sector data of S1(x) or S2(x) includes an error beyond an error correction capability, the erroneous sector data can be corrected by an XOR inverse operation with the parity sector and the one sector data without error.

For example, when S1(x) and SP(x) can be properly error-corrected and S2(x) cannot be error-corrected, S2(x) can be restored by the following equation:

S2(x)=S1(x)+SP(x)

However, when S1(x) and S2(x) cannot be error-corrected, E1(x) and E2(x) take values other than 0 and error correction cannot be made by an XOR inverse operation.

Nevertheless, when it can be determined that error position information at bit positions (y) included in the two error syndromes E1(x) and E2(x) are independent from each other, an XOR operation holds and bit correction can be made by the parity sector.

As a results, when S1(x) and S2(x) cannot be error-corrected, only the bits correctable by the parity sector are corrected. After the correction, when S1(x) and S2(x) include only erroneous bits within the error correction capability, all the errors in S1(x) can be corrected with the error correction capability of S1(x). When all the errors in S1(x) can be corrected, S2(x) can be corrected by the parity sector even when only S2(x) includes errors beyond the error correction capability.

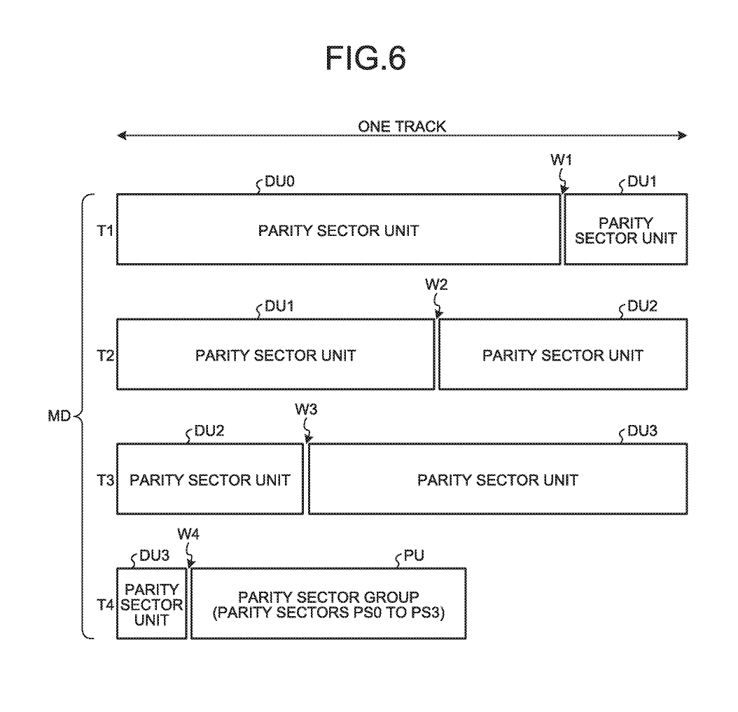

FIG. 6 is a diagram illustrating an example of media data written into the magnetic disk device according to the embodiment. FIG. 6 illustrates a method of recording continuously four parity sector units in the magnetic disk 2. However, this can be understood as a method of recording continuously N parity sector units in the magnetic disk 2.

Referring to FIG. 6, the four parity sector units DU0 to DU3 are continuously recorded across the tracks T1 to T4. In this case, the parity sector units DU0 to DU3 can be configured by host data HD illustrated in FIG. 4A. When the parity sector units DU0 to DU3 are continuously recorded across the tracks T1 to T4, as illustrated in FIG. 4B, the sector data P0 to P3 can be interleaved for the individual sector groups in the parity sector units DU0 to DU3.

At that time, the boundaries between the parity sector units DU0 to DU3 may be arranged in the middle of one track or the parity sector units DU0 to DU3 may extend across a plurality of tracks. For example, a boundary W1 between the parity sector units DU0 and DU1 is arranged in the middle of the track T1. A boundary W2 between the parity sector units DU1 and DU2 is arranged in the middle of the track T2. A boundary W3 between the parity sector units DU2 and DU3 is arranged in the middle of the track T3. The parity sector unit DU1 extends across the tracks T1 and T2. The parity sector unit DU2 extends across the tracks T2 and T3. The parity sector unit DU3 extends across the tracks T3 and T4.

The track 14 records a parity sector groups PU including parity sectors PS0 to PS3 of the parity sector units DU0 to DU3 subsequent to the parity sector unit DU3. The parity sector group PU can have four parity sectors PS0 to PS3 corresponding to the parity sector units DU0 to DU3. In the example of FIG. 5, the data length of the parity sector group PU is 4 sectors, and the data length of the parity sector units DU0 to DU3 is 12 sectors.

In the example of FIG. 6, a boundary W4 between the parity sector unit DU3 and the parity sector group PU is arranged in the middle of the track T4. The parity sector group PU is data in which the four parity sectors PS0 to PS3 are interleaved as illustrated in FIG. 4B. In this example, the plurality of sector data units DU0 to DU3 and the parity sector group PU continuously recorded in the magnetic disk 2 are set as media data MD.

FIG. 6 illustrates the example in which the parity sector group PU is recorded subsequent to the parity sector unit DU3. Alternatively, the parity sector group PU may be recorded in any region other than the arrangement region of the parity sector units DU0 to DU3. In addition, the parity sector group PU corresponding to the parity sector units DU0 to DU3 and a parity sector group corresponding to other parity sector units may be recorded in one track. Alternatively, one parity sector group PU may be configured to be longer than one track length. In this case, by increasing the number of parity sectors included in the one parity sector group, the data length of the one parity sector group can be made longer.

By recording continuously the parity sector units DU0 to DU3 in the plurality of tracks T1 to T4, the parity sector group PU can be recorded in any position other than those of the parity sector units DU0 to DU3. In this case, the parity sector group PU can be collectively recorded at one position on the outer peripheral side or inner peripheral side of the magnetic disk 2 to prevent mismatching between physical block addresses at which parity sectors are counted and logical block addresses at which no parity sectors are counted.

For example, all the parity sector groups are collectively recorded at one place on the inner peripheral side of the magnetic disk 2. In this case, the physical block addresses and the logical block addresses can be allocated in sequence to the recording regions for the parity sector units from the outer peripheral side of the magnetic disk 2. The physical block addresses and the logical block addresses can be equal. When the physical block addresses and the logical block addresses are allocated in sequence to the recording regions for the parity sector units, only the physical block addresses can be allocated to the recording regions for the parity sector groups.

In addition, by recording continuously the parity sector units DU0 to DU3 across the plurality of tracks T1 to T4, it is not necessary to allocate the tracks T1 to T4 separately to the parity sector units DU0 to DU3 and record the parity sectors PS0 to PS3 corresponding to the parity sector units DU0 to DU3 in terminal ends of the tracks T1 to T4 (in general, the final sector position in the same track). This eliminates the need for the read head HR to run the parity sectors at each time of reading the individual parity sector units DU0 to DU3, thereby improving reading performance.

In addition, it is not necessary to wait for generation of parity sectors to write the corresponding parity sectors into the terminal ends of the tracks in which the parity sector units DU0 to DU3 are written, thereby improving writing performance as well. Further, the parity sectors need to be read only when a read error is detected at the time of reading the sector data, thereby reducing deterioration in reading performance caused by unnecessary reading of the parity sectors.

By recording the parity sector group PU in any position other than those of the parity sector units DU0 to DU3, it is possible to fix the parity data length and the number of the sector data for use in generation of the parity data even when the number of sectors in the tracks is different among the zones ZA, ZB, and ZC.

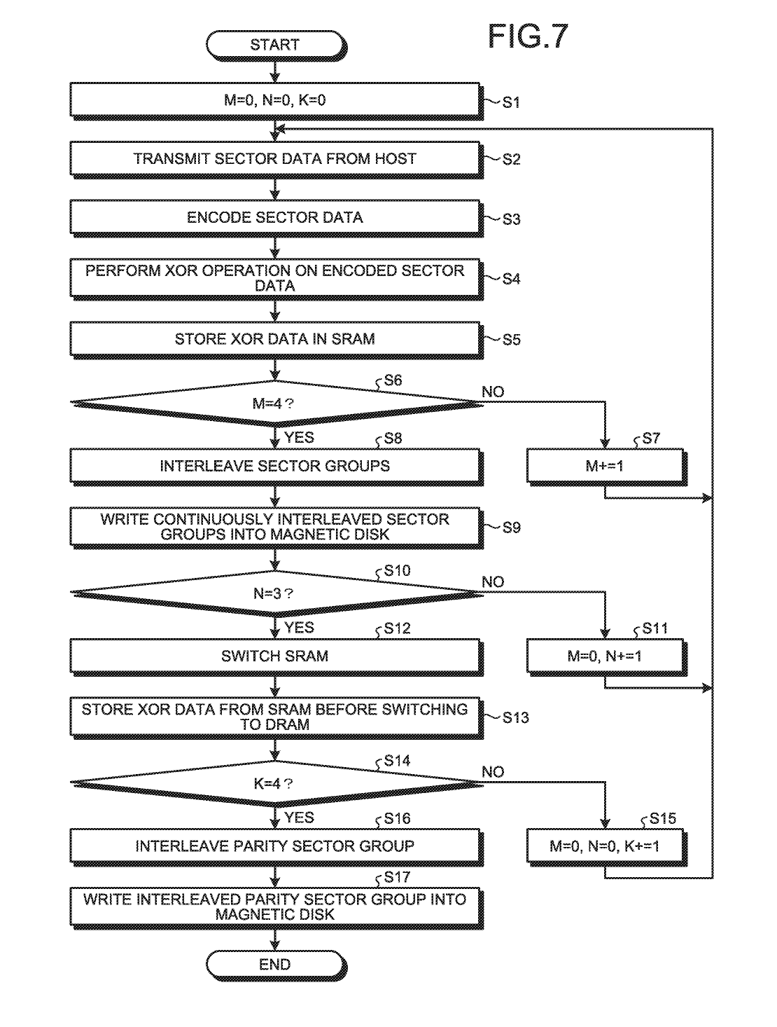

FIG. 7 is a flowchart of an example of a generating method of media data applied to the magnetic disk device according to the embodiment. Referring to FIG. 7, the case where M=4, N=3, and K=4 (that is, sector groups are generated from M=4 sector data, parity sector units are generated from N=3 sector groups, and K=4 parity sector units are recorded) as illustrated in FIGS. 5 and 6 will be explained.

First, the CPU 11 sets M to 0, N to 0, and K to 0 (S1). Then, the host HS transmits sector data (S2), the sector data is sent to the encoder 13 via the DRAM 12 and the hard disk control unit 9, and encoded at the encoder 13 by the LDPC codes (S3). The encoded sector data can be sent to the interleaver 17 and held in the interleaver 17.

Next, the XOR unit 14 performs an XOR operation on the encoded sector data (S4), and stores the same in either of the SRAMs 15 and 16 (S5). Then, the CPU 11 determines whether M is equal to 4 (S6). When M is not equal to 4 (S6: No), the CPU 11 increments M by one (S7) and then returns to S2. When steps S2 to S7 are repeated. until M becomes equal to 4 (S6: Yes), the sector group GD0 illustrated in FIG. 5 is generated. The interleaver 17 interleaves four sector data in the sector group GD0 sent from the encoder 13 (S8), and writes the interleaved sector group GD0 into the magnetic disk 2 (S9).

Next, the CPU 11 determines whether N is equal to 3 (S10). When N is not equal to 3 (S10: No), the CPU 11 set M to 0 and increments N by one (S11), and then returns to S2. Then, when steps S2 to S7 are repeated until M becomes 4 (S10: Yes), the sector group GD1 illustrated in FIG. 5 is generated. Then, the interleaver 17 interleaves four sector data in the sector group GD1 sent from the encoder 13 (S8), and writes the interleaved sector group GD1 into the magnetic disk 2 subsequent to the sector group GD0 (S9).

Next, the CPU 11 determines whether N is equal to 3 (S10). When N is not equal to 3 (S10: No), the CPU 11 sets M to 0 and increments N by one (S11), and then returns to S2. Then, when steps S2 to S7 are repeated until M becomes 4 (S10: Yes), the sector group GD2 illustrated in FIG. 5 is generated. Then, the interleaver 17 interleaves four sector data in the sector group GD2 sent from the encoder 13 (S8), and writes the interleaved sector group GD2 into the magnetic disk 2 subsequent to the sector group GD1 (S9). In this case, when the three interleaved sector groups GD0 to GD2 are continuously written into the magnetic disk 2, the parity sector unit DU0 is recorded in the magnetic disk 2.

The interleaver 17 can have a storage region for four sector data. The storage region can be provided as SRAM capable of high-speed random access. For example, to interleave the four sector data in the sector group GD0, the interleaver 17 can hold the four sector data and interleave the four sector data when they are all available. Then, while writing the interleaved sector group GD0 into the magnetic disk 2, the interleaver 17 can hold sequentially four sector data in the next sector group GD1 in the empty region after the writing of the sector group GD0.

Alternatively, the interleaver 17 can have two storage regions (for example, SRAMs) for four sector data. For example, to interleave the four sector data in the sector group GD0, the interleaver 17 can hold the four sector data in the first storage region, and can interleave the four sector data when they are all available in the first storage region, and then write the interleaved sector group GD0 into the magnetic disk 2.

In addition, when the encoder 13 sends the sector data in the sector group GD1 to the interleaver 17 while the interleaver 17 interleaves the four sector data in the sector group GD0, the interleaver 17 can hold the four sector data in the sector group GD1 in the second storage region. Then, the interleaver 17 can interleave the four sector data when they are ail available in the second storage region, and write the interleaved sector group GD1 into the magnetic disk 2.

When steps S2 to S11 are repeated until N becomes equal to 3 (S10: Yes), the CPU 11 switches the storage destination of the results of the XOR operation between the SRAM 15 and 16 (S12). By switching the storage destination of the results of the XOR operation at the time of switching between the parity sector units, it is possible to continue encoding and XOR operation of the sector data included in the next parity sector unit and prevent overwriting the results of the XOR operation. Accordingly, while writing continuously the parity sector units into the magnetic disk 2, the parity data corresponding to the written parity sector units can be maintained.

Then, the CPU 11 stores the results of the XOR operation stored in the SRAM 15 or 16 before the switching into the DRAM 12 (S13). The results of the XOR operation can be used as parity sector PS0 in the parity sector unit DU0. The results of the XOR operation can be stored into the DRAM 12 while the sector data unit DU0 is being written into the magnetic disk 2. When the parity sector unit DU0 is written, the loop of S2 to S7 is repeated 12 times. Accordingly, the results of the XOR operation are the results of the XOR operation on the 12 sector data for use in generation of the parity sector unit DU0 as illustrated in FIG. 5.

Next, the CPU 11 determines whether K is equal to 4 (S14). When K is not equal to 4 (S14: No), the CPU 11 sets M to 0 and N to 0 and increments K by one (S15), and then returns to S2. When steps S2 to S15 are repeated until K becomes equal to 4 (S14: Yes), the parity sector units DU0 to DU3 (part of the media data MD) are continuously written into the magnetic disk 2 as illustrated in FIG. 6. The DRAM 12 stores the four parity sectors PS0 to PS3 in the parity sector units DU0 to DU3.

The four parity sectors PS0 to PS3 stored in the DRAM 12 are sent to the interleaver 17 bypassing the encoder 13. The parity sectors PS0 to PS3 are generated by the XOR operation on the encoded sector data (S4). Accordingly, bypassing the encoder 13 for the parity sectors PS0 to PS3 makes it possible to prevent the parity sectors PS0 to PS3 from being doubly encoded. The interleaver 17 interleaves the four parity sectors PS0 to PS3 having bypassed the encoder 13 to generate the parity sector group PU (S16), and the parity sector group PU is written into the magnetic disk 2 (S17).

Accordingly, the parity sectors PS0 to PS3 can be interleaved and turned into long sectors, and written into the magnetic disk 2. This makes it possible to interleave all the media data MD to be written into the magnetic disk 2 before writing into the magnetic disk 2, thereby improving the LDPC correction probability. In this case, by interleaving individually the sector groups, even when the parity sector units are composed of 12 sectors and the parity sector groups are composed of four sectors, the parity sector units and the parity sector groups can be interleaved by four sectors, thereby communalizing the unit of processing for interleaving.

In the foregoing embodiment, the two SRAMs 15 and 16 are provided to switch the storage destinations of the results of the XOR operation on the sector data. Alternatively, the storage regions in one SRAM may be switched.

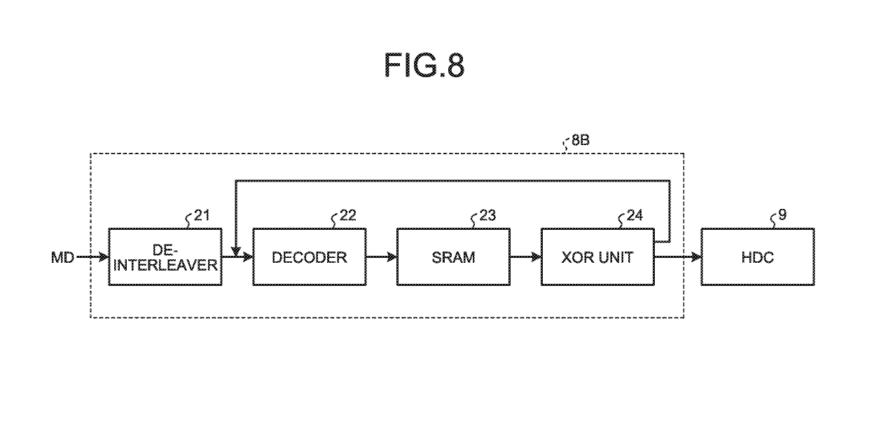

FIG. 8 is a block diagram of a configuration example of the decoding unit illustrated in FIG. 1.

Referring to FIG. 8, the decoding unit SB includes a deinterleaver 21, a decoder 22, SRAM 23, and an XOR unit 24. The deinterleaver 21 can deinterleave the sector data included in the parity sector units by sector group and can deinterleave the parity sectors included in the parity sector groups. The decoder 22 can decode the individual sector data read from the magnetic disk 2 by the LDPC codes. The SRAM 23 can store the results of decoding (hard decision) by the decoder 22 and error syndromes. The error syndromes can indicate the positions of erroneous bits.

The XOR unit 24 can perform an XOR operation on M×N−1 sector data without error in a parity sector unit including M×N sector data and one parity sector corresponding to the parity sector unit by bit, thereby to restore one erroneous sector data in the parity sector unit. In this case, the XOR unit 24 can be given two output destinations. The first one is the hard disk control unit 9 and the second one is the decoder 22.

When two or more sector data in the parity sector unit have errors, the XOR unit 24 can refer to the error syndromes to locate the correct bit positions of the erroneous sector data, and perform an XOR operation using the parity sectors on the located bit positions to correct the bits in the erroneous sector data. Then, when all the bits in the erroneous sector data are corrected, the corrected sector data can be output to the hard disk control unit 9.

When all the bits in the erroneous sector data are not corrected, the erroneous sector data with some of the bits corrected can be output to the decoder 22. When the erroneous sector data with some of the bits corrected fall within the error correction capability of the decoder 22, all the bits in the erroneous sector data with some of the bits corrected can be corrected.

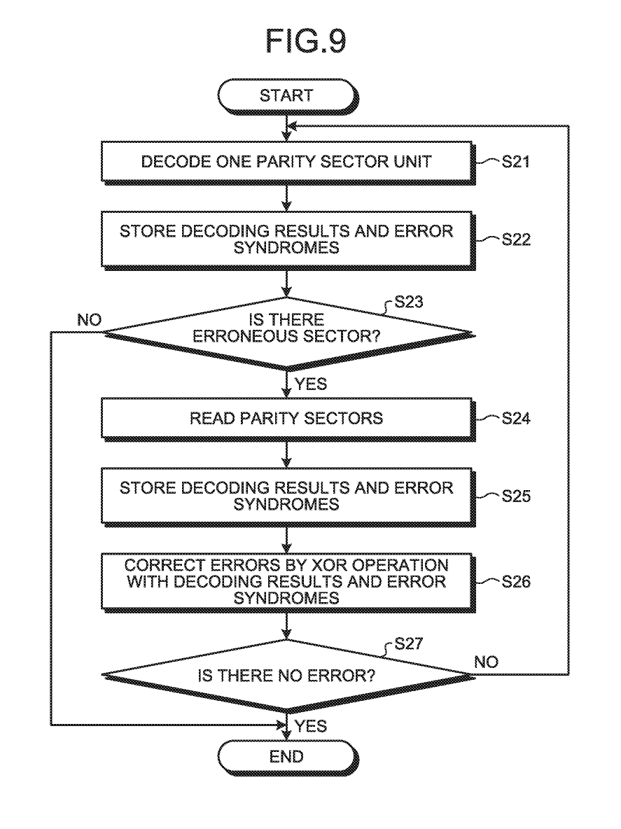

FIG. 9 is a flowchart of an example of a decoding method of the media data applied to the magnetic disk device according to the embodiment. FIG. 9 describes an example of the one parity sector unit DU0 illustrated in FIG. 6. However, this method is also applicable to decoding of the other sector data units DU1 to DU3 illustrated in FIG. 6.

The parity sector unit DU0 read from the magnetic disk 2 is deinterleaved by the deinterleaver 21 and sent to the decoder 22.

Next, the decoder 22 decodes the individual sector data in the parity sector unit DU0 by the LDPC codes (S21). Then, the results of decoding by the decoder 22 and error syndromes are stored in the SRAM 23 (S22).

Next, it is determined whether there is any erroneous sector data shown in the results of decoding by the decoder 22 (3). When there is no erroneous sector data (S23: No), the process is terminated. When there is some erroneous sector data (S23: Yes), the parity sector PS0 in the parity sector unit DU0 is read from the magnetic disk 2 (S24).

The parity sector PS0 in the parity sector unit DU0 is turned into a long sector together with the parity sectors PS1 to PS3 in the parity sector units DU1 to DU3. Therefore, the parity sector group PU illustrated in FIG. 6 is read from the magnetic disk 2 and deinterleaved by the deinterleaver 21 to acquire the parity sector PS0 in the parity sector unit DU0. This step (S24) may be performed after the decoding of the other sector data units DU1 to DU3.

Next, the decoder 22 decodes the parity sector PS0 in the parity sector unit DU0 by the LDPC codes. Then, the results of decoding by the decoder 22 and error syndromes are stored in the SRAM 23 (S25).

Then, the XOR unit 24 makes error correction by an XOR operation with the results of decoding and the error syndromes (S26).

It is determined whether, as a result of the error correction by the XOR unit 24, there is no error (S27). When there is no error (S27: Yes), the process is terminated. When there is some error (S27: No), the parity sector unit DU0 after the error correction by the XOR unit 24 is sent to the decoder 22. Then, steps S21 to S27 are repeated until there exists no longer error in the parity sector unit DU0. Accordingly, even when a plurality of sector data in the parity sector unit DU0 is erroneous, it is possible to correct the plurality of sector data in the parity sector unit DU0.

The parity sector units DU0 to DU3 are encoded by the encoder 13 in such a manner that 0 and 1 are alternately or evenly arranged as much as possible so that there is no data series in which 1 is continuous, for example. However, as for the parity sector group PU, the restriction on the arrangement of 0 and 1 by the encoder 13 may break down due to the XOR operation.

Accordingly, the decoder 22 may change parameters for LDPC decoding between the parity sector units DU0 to DU3 and the parity sector group PU, depending on the difference in frequency characteristic between the parity sector units DU0 to DU3 and the parity sector group PU. This makes it possible to improve the overall error rate characteristic of the parity sector units DU0 to DU3 and the parity sector groups PU.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk; and
a control unit that generates sector groups from M (M is an integer of 2 or larger) sector data, generates one parity sector unit from N (N is an integer of 1 or larger) sector groups in which the M sector data are interleaved for the individual sector groups, writes continuously K (K is an integer of 2 or larger) parity sector units into the magnetic disk, generates one parity sector group in which K parity sectors corresponding to the K parity sector units are turned into long sector, and writes the generated one parity sector group into the magnetic disk independently from the K parity sector units.

2. The magnetic disk device of claim 1, wherein the M and the K are equal to.

3. The magnetic disk device of claim 1, wherein a boundary between the two consecutive parity sector units is recorded in the middle of one track.

4. The magnetic disk device of claim 1, further comprising an interleaver that interleaves the sector data in the parity sector units and interleaves the parity sectors in the parity sector group.

5. The magnetic disk device of claim 1, further comprising a deinterleaver that deinterleaves the sector data read from the magnetic disk in the parity sector units and deinterleaves the parity sectors read from the magnetic disk in the parity sector group.

6. The magnetic disk device of claim. 1, further comprising an encoder that encodes the parity sector units and bypasses encoding of the parity sector group.

7. The magnetic disk device of claim 1, further comprising SRAM that holds parity sectors corresponding to the parity sector units, wherein
upon completion of generation of the parity sector units, a storage region of the SRAM for the parity sectors is switched and the parity sectors held in the storage region of the SRAM before the switching are stored into a storage region other than the storage region of the SRAM.

8. The magnetic disk device of claim 1, further comprising a decoder that decodes the parity sector units and the parity sector group, wherein
the decoder changes parameters for decoding between the parity sector units and the parity sector group depending on difference in frequency characteristic between the parity sector units and the parity sector group.

9. The magnetic disk device of claim 1, further comprising a decoding unit that, when there is an error in one sector data in the parity sector unit including M×N sector data, performs a bitwise exclusive OR (XOR) operation on the M×N−1 sector data without error and one parity sector corresponding to the parity sector unit to restore the one erroneous sector data.

10. The magnetic disk device of claim 9, wherein, when there are errors in two or more sector data in the parity sector unit, the decoding unit refers to error syndromes to locate correct bit positions of the erroneous sector data, and performs an XOR operation using the parity sectors on the located bit positions to correct the bits in the erroneous sector data, and when all the bits in the erroneous sector data are not corrected, the decoding unit decodes the erroneous sector data of which some of the bits are corrected.

11. A data processing device comprising:
a first generation unit that generates sector groups from M (M is an integer of 2 or larger) sector data, and generates one parity sector unit from N (N is an integer of 1 or larger) sector groups in which the M sector data are interleaved for the individual sector groups; and
a second generation. unit that generates one parity sector group in which K (K is an integer of 2 or larger) parity sectors corresponding to the K parity sector units are turned into long sector.

12. The data processing device of claim 11, wherein the M and the K are equal to.

13. The data processing device of claim 11, further comprising an interleaver that interleaves the sector data in the parity sector units and interleaves the parity sectors in the parity sector group.

14. The data processing device of claim 11, further comprising an encoder that encodes the parity sector units and bypasses encoding of the parity sector group.

15. The data processing device of claim 11, further comprising a decoding unit that, when there is an error in one sector data in the parity sector unit including M×N sector data, performs a bitwise exclusive OR (XOR) operation on the M×N−1 sector data without error and one parity sector corresponding to the parity sector unit to restore the one erroneous sector data.

16. The data processing device of claim 15, wherein, when there are errors in two or more sector data in the parity sector unit, the decoding unit refers to error syndromes to locate correct bit positions of the erroneous sector data, and perform an XOR operation using the parity sectors on the located bit positions to correct the bits in the erroneous sector data, and when all the bits in the erroneous sector data are not corrected, the decoding unit decodes the erroneous sector data with some of the bits corrected.

17. A data recording method for a magnetic disk device including a magnetic disk, comprising:
generating sector groups from M (M is an integer of 2 or larger) sector data, generating one parity sector unit from N (N is an integer of 1 or larger) sector groups in which the M sector data are interleaved for the individual sector groups, writing continuously K (K is an integer of 2 or larger) parity sector units into the magnetic disk, generating one parity sector group in which K parity sectors corresponding to the K parity sector units are turned into long sector, and writing the generated one parity sector group into the magnetic disk independently from the K parity sector units.

18. The data recording method of claim 17, wherein the M and the K are equal to.

19. The data recording method of claim 17, further comprising interleaving the sector data in the parity sector units and writing continuously interleaved sector data into the magnetic disk, and interleaving the parity sectors in the parity sector group and writing interleaved parity sectors into the magnetic disk.

20. The data recording method of claim 17, further comprising encoding the parity sector units, and bypassing to encode the parity sector group.
